(19) United States
(12) Patent Application Publication
(10) Pub. No.: US 2015/0117653 A1
(43) Pub. Date: Apr. 30, 2015

(54) METHOD AND APPARATUS FOR EVALUATING AUDIO STREAM QUALITY

(71) Applicant: Huawei Technologies Co., Ltd., Shenzhen (CN)

(72) Inventors: Shan Gao, Shenzhen (CN); Lina Sun, Shenzhen (CN); Fuzheng Yang, Xi'an (CN)

(21) Appl. No.: 14/586,052

(22) Filed: Dec. 30, 2014

Related U.S. Application Data
(63) Continuation of application No. PCT/CN2013/081071, filed on Aug. 8, 2013.

(30) Foreign Application Priority Data
Aug. 21, 2012 (CN) 201210298856.2

(51) Int. Cl. G10L 25/00

(52) U.S. Cl. CPC G10L 25/00
USPC 381/56

(57) ABSTRACT

Embodiments of the present invention provide a method and an apparatus for evaluating audio stream quality, where the method for evaluating audio stream quality includes: determining at least one non-silence audio data packet in a to-be-evaluated audio stream, where the to-be-evaluated audio stream includes at least one non-silence audio data packet, and each non-silence audio data packet includes at least one non-silence audio frame; and evaluating the at least one non-silence audio data packet in the to-be-evaluated audio stream to generate audio quality evaluation information. The method and the apparatus for evaluating audio stream quality provided by the embodiments of the present invention can avoid impact of a silence part on evaluation of audio quality, thereby improving accuracy of evaluating audio stream quality.

### CROSS-REFERENCE TO RELATED APPLICATIONS

This application is a continuation of International Application No. PCT/CN2013/081071, filed on Aug. 8, 2013, which claims priority to Chinese Patent Application No. 201210298856.2, filed on Aug. 21, 2012, both of which are hereby incorporated by reference in their entireties.

### TECHNICAL FIELD

Embodiments of the present invention relate to network audio technologies, and in particular, to a method and an apparatus for evaluating audio stream quality.

### BACKGROUND

In recent years, rapid development of a digital network and a super-large-scale integrated circuit technology has resulted in constant emergence of various audio processing technologies and audio transmission technologies. Subjective feelings of communication users and consumers for audio ultimately depend on audio quality, and therefore, audio and video quality assessment becomes an increasingly important research topic. Network audio transmission technologies have become a significant application and undertake an increasing number of audio communication tasks. In a process of audio transmission, due to multiple network factors, a packet loss occurs in audio and affects audio quality consequently. Accurate and reliable measurement and evaluation of network audio quality is a fairly key problem in network measurement and network planning and design.

In the prior art, a method for evaluating audio quality is generally performed according to a transmission status of all audio data packets in a section of an audio stream, and an evaluation result is inaccurate.

### SUMMARY

Embodiments of the present invention provide a method and an apparatus for evaluating audio stream quality, so as to improve accuracy of evaluating audio stream quality.

According to a first aspect, an embodiment of the present invention provides a method for evaluating audio stream quality, including:

determining at least one non-silence audio data packet in a to-be-evaluated audio stream, where the to-be-evaluated audio stream includes at least one non-silence audio data packet, and each non-silence audio data packet includes at least one non-silence audio frame; and

evaluating the at least one non-silence audio data packet in the to-be-evaluated audio stream to generate audio quality evaluation information.

In a first possible implementation manner, the evaluating the at least one non-silence audio data packet in the to-be-evaluated audio stream to generate audio quality evaluation information includes:

determining a bit rate of the at least one non-silence audio data packet in the to-be-evaluated audio stream, and acquiring code compression quality information according to the bit rate; and

determining packet loss status information of the at least one non-silence audio data packet in the to-be-evaluated audio stream, and generating the audio quality evaluation information according to the code compression quality information and the packet loss status information.

With reference to the first possible implementation manner of the first aspect, in a second possible implementation manner, the determining a bit rate of the at least one non-silence audio data packet in the to-be-evaluated audio stream is specifically:

determining a sum of bits of all non-silence audio frames included in the at least one non-silence audio data packet in the to-be-evaluated audio stream and a sum of time lengths of all the non-silence audio frames, and generating the bit rate according to the sum of bits and the sum of time lengths.

With reference to the first or second implementation manner of the first aspect, in a third possible implementation manner, the determining packet loss status information of the at least one non-silence audio data packet in the to-be-evaluated audio stream, and generating the audio quality evaluation information according to the code compression quality information and the packet loss status information is specifically:

determining a packet loss rate of the at least one non-silence audio data packet in the to-be-evaluated audio stream, and generating the audio quality evaluation information according to the code compression quality information and the packet loss rate.

With reference to the third possible implementation manner of the first aspect, in a fourth possible implementation manner, the determining a packet loss rate of the at least one non-silence audio data packet in the to-be-evaluated audio stream is specifically:

determining the total number of lost audio data packets and the number of lost silence audio data packets in the to-be-evaluated audio stream, determining the number of lost non-silence audio data packets according to the total number of the lost audio data packets and the number of the lost silence audio data packets, and generating the packet loss rate according to the number of the at least one lost non-silence audio data packets and the number of non-silence audio data packets in the to-be-evaluated audio stream.

With reference to the third possible implementation manner of the first aspect, in a fifth possible implementation manner, the generating the audio quality evaluation information according to the code compression quality information and the packet loss rate is specifically:

calculating the audio quality evaluation information Q by applying the following formula:

Q=Q_{c}−a₁·Q_{c}·e^{a}^{₂}^{PLR},

where Q_{c} is the code compression quality information, PLR is the packet loss rate, and a₁ and a₂ are separately a preset coefficient.

With reference to the first or second implementation manner of the first aspect, in a sixth possible implementation manner, the packet loss status information is loss frequency; and
the determining packet loss status information of the at least one non-silence audio data packet in the to-be-evaluated audio stream, and generating the audio quality evaluation information according to the code compression quality information and the packet loss status information is specifically:

determining loss frequency of the at least one non-silence audio data packet in the to-be-evaluated audio stream, and generating the audio quality evaluation information according to the code compression quality information and the loss frequency.

With reference to the sixth possible implementation manner of the first aspect, in a seventh possible implementation manner, the determining loss frequency of the at least one non-silence audio data packet in the to-be-evaluated audio stream is specifically:

determining the number of loss times of the at least one non-silence audio data packet in the to-be-evaluated audio stream, determining the sum of time lengths of all the non-silence audio frames included in the at least one non-silence audio data packet in the to-be-evaluated audio stream, and generating the loss frequency according to the number of loss times and the sum of time lengths of all the non-silence audio frames.

With reference to the sixth possible implementation manner of the first aspect, in an eighth possible implementation manner, the generating the audio quality evaluation information according to the code compression quality information and the loss frequency is specifically:

calculating the audio quality evaluation information Q by applying the following formula:

Q=Q_{c}−a₃·Q_{c}·e^{a}^{₄}^{LR},

where Q_{c} is the code compression quality information, LR is the loss frequency, and a₃ and a₄ are separately a preset coefficient.

With reference to the first or second implementation manner of the first aspect, in a ninth possible implementation manner, the packet loss status information is an average loss length; and

the determining packet loss status information of the at least one non-silence audio data packet in the to-be-evaluated audio stream, and generating the audio quality evaluation information according to the code compression quality information and the packet loss status information is specifically:

determining an average loss length of the at least one non-silence audio data packet in the to-be-evaluated audio stream, and generating the audio quality evaluation information according to the code compression quality information and the average loss length.

With reference to the ninth possible implementation manner of the first aspect, in a tenth possible implementation manner, the determining an average loss length of the at least one non-silence audio data packet in the to-be-evaluated audio stream is specifically:

determining at least one lost non-silence audio data packet in the to-be-evaluated audio stream, determining a sum of time lengths of the at least one lost non-silence audio data packet, determining the number of loss times of the at least one non-silence audio data packet in the to-be-evaluated audio stream, and generating the average loss length according to the sum of time lengths and the number of loss times.

With reference to the ninth possible implementation manner of the first aspect, in an eleventh possible implementation manner, the generating the audio quality evaluation information according to the code compression quality information and the loss frequency is specifically:

calculating the audio quality evaluation information Q by applying the following formula:

Q=Q_{c}−a₅·Q_{c}·e^{a}^{₆}^{LD},

where Q_{c} is the code compression quality information, LD is the average loss length, and a₅ and a₆ are separately a preset coefficient.

According to a second aspect, an embodiment of the present invention provides an apparatus for evaluating audio stream quality, including:

a non-silence determining unit, configured to determine at least one non-silence audio data packet in a to-be-evaluated audio stream, where the to-be-evaluated audio stream includes at least one non-silence audio data packet, and each non-silence audio data packet includes at least one non-silence audio frame; and

an evaluation unit, connected to the non-silence determining unit and configured to evaluate the at least one non-silence audio data packet in the to-be-evaluated audio stream to generate audio quality evaluation information.

In a first possible implementation manner, the evaluation unit includes:

an acquiring sub-unit, connected to the non-silence determining unit and configured to determine a bit rate of the at least one non-silence audio data packet in the to-be-evaluated audio stream, and acquire code compression quality information according to the bit rate; and

an evaluation sub-unit, connected to the acquiring sub-unit and configured to determine packet loss status information of the at least one non-silence audio data packet in the to-be-evaluated audio stream, and generate the audio quality evaluation information according to the code compression quality information and the packet loss status information.

With reference to the first possible implementation manner of the second aspect, in a second possible implementation manner, the acquiring sub-unit is further configured to determine a sum of bits of all non-silence audio frames included in the at least one non-silence audio data packet in the to-be-evaluated audio stream and a sum of time lengths of all the non-silence audio frames, and generate the bit rate according to the sum of bits and the sum of time lengths.

With reference to the first or second implementation manner of the second aspect, in a third possible implementation manner, the packet loss status information is a packet loss rate; and

the evaluation sub-unit is further configured to determine a packet loss rate of the at least one non-silence audio data packet in the to-be-evaluated audio stream, and generate the audio quality evaluation information according to the code compression quality information and the packet loss rate.

With reference to the third implementation manner of the second aspect, in a fourth possible implementation manner, the evaluation sub-unit is further configured to determine the total number of lost audio data packets and the number of lost silence audio data packets in the to-be-evaluated audio stream, determine the number of lost non-silence audio data packets according to the total number of the lost audio data packets and the number of the lost silence audio data packets, and generate the packet loss rate according to the number of the at least one lost non-silence audio data packets and the number of non-silence audio data packets in the to-be-evaluated audio stream.

With reference to the third implementation manner of the second aspect, in a fifth possible implementation manner, the evaluation sub-unit is further configured to calculate the audio quality evaluation information Q by applying the following formula:

Q=Q_{c}−a₁·Q_{c}·e^{a}^{₂}^{PLR},

where Q_{c} is the code compression quality information, PLR is the packet loss rate, and a₁ and a₂ are separately a preset coefficient.

With reference to the first or second implementation manner of the second aspect, in a sixth possible implementation manner, the packet loss status information is loss frequency; and

the evaluation sub-unit is further configured to determine loss frequency of the at least one non-silence audio data packet in the to-be-evaluated audio stream, and generate the audio quality evaluation information according to the code compression quality information and the loss frequency.

With reference to the sixth implementation manner of the second aspect, in a seventh possible implementation manner, the evaluation sub-unit is further configured to determine the number of loss times of the at least one non-silence audio data packet in the to-be-evaluated audio stream, determine the sum of time lengths of all the non-silence audio frames included in the at least one non-silence audio data packet in the to-be-evaluated audio stream, and generate the loss frequency according to the number of loss times and the sum of time lengths of all the non-silence audio frames.

With reference to the sixth implementation manner of the second aspect, in an eighth possible implementation manner, the evaluation sub-unit is further configured to calculate the audio quality evaluation information Q by applying the following formula:

Q=Q_{c}−a₃·Q_{c}·e^{a}^{₄}^{LR},

where Q_{c} is the code compression quality information, LR is the loss frequency, and a₃ and a₄ are separately a preset coefficient.

With reference to the first or second implementation manner of the second aspect, in a ninth possible implementation manner, the packet loss status information is an average loss length; and

the evaluation sub-unit is further configured to determine an average loss length of the at least one non-silence audio data packet in the to-be-evaluated audio stream, and generate the audio quality evaluation information according to the code compression quality information and the average loss length.

With reference to the ninth implementation manner of the second aspect, in a tenth possible implementation manner, the evaluation sub-unit is further configured to determine at least one lost non-silence audio data packet in the to-be-evaluated audio stream, determine a sum of time lengths of the at least one lost non-silence audio data packet, determine the number of loss times of the at least one non-silence audio data packet in the to-be-evaluated audio stream, and generate the average loss length according to the sum of time lengths and the number of loss times.

With reference to the ninth implementation manner of the second aspect, in an eleventh possible implementation manner, the evaluation sub-unit is further configured to calculate the audio quality evaluation information Q by applying the following formula:

Q=Q_{c}−a₅·Q_{c}·e^{a}^{₆}^{LD},

where Q_{c} is the code compression quality information, LD is the average loss length, and a₅ and a₆ are separately a preset coefficient.

It can be learned from the foregoing technical solutions that, in the method and the apparatus for evaluating audio stream quality according to the embodiments of the present invention, the apparatus for evaluating audio stream quality determines at least one non-silence audio data packet in a to-be-evaluated audio stream, where the to-be-evaluated audio stream includes at least one non-silence audio data packet, and each non-silence audio data packet includes at least one non-silence audio frame; and evaluates the at least one non-silence audio data packet in the to-be-evaluated audio stream to generate audio quality evaluation information. Because a silence audio data packet does not include any useful information, audio stream quality evaluation is performed only on at least one non-silence audio data packet in a to-be-evaluated audio stream, which can avoid impact of a silence part on evaluation of audio quality, thereby improving accuracy of evaluating audio stream quality.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show some embodiments of the present invention, and a person of ordinary skill in the art may still derive other drawings from these accompanying drawings without creative efforts.

FIG. 1 is a flowchart of a method for evaluating audio stream quality according to an embodiment of the present invention;

FIG. 2 is a flowchart of another method for evaluating audio stream quality according to an embodiment of the present invention;

FIG. 3 is a schematic structural diagram of an apparatus for evaluating audio stream quality according to an embodiment of the present invention; and

FIG. 4 is a schematic structural diagram of another apparatus for evaluating audio stream quality according to an embodiment of the present invention.

### DETAILED DESCRIPTION

To make the objectives, technical solutions, and advantages of the embodiments of the present invention clearer, the following clearly describes the technical solutions in the embodiments of the present invention with reference to the accompanying drawings in the embodiments of the present invention. Apparently, the described embodiments are a part rather than all of the embodiments of the present invention. All other embodiments obtained by a person of ordinary skill in the art based on the embodiments of the present invention without creative efforts shall fall within the protection scope of the present invention.

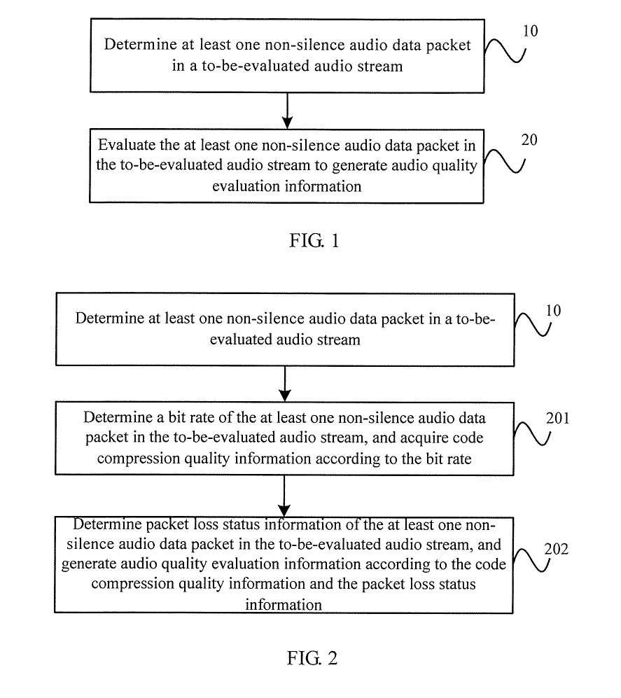

FIG. 1 is a flowchart of a method for evaluating audio stream quality according to an embodiment of the present invention. As shown in FIG. 1, the method for evaluating audio stream quality according to this embodiment of the present invention may specifically be applied to a process of evaluating quality of an audio stream, and in particular, of a network audio stream. The network audio stream is specifically an audio stream transmitted over a network. The method for evaluating audio stream quality according to this embodiment of the present invention may be executed by an apparatus for evaluating audio stream quality, where the apparatus for evaluating audio stream quality may be implemented in a manner of software and/or hardware.

The method for evaluating audio stream quality according to this embodiment of the present invention specifically includes:

Step 10: Determine at least one non-silence audio data packet in a to-be-evaluated audio stream, where the to-be-evaluated audio stream includes at least one non-silence audio data packet, and each non-silence audio data packet includes at least one non-silence audio frame.

Step 20: Evaluate the at least one non-silence audio data packet in the to-be-evaluated audio stream to generate audio quality evaluation information.

Specifically, when quality evaluation is performed on a section of an audio stream, the section of the audio stream is namely a to-be-evaluated audio stream, where the to-be-evaluated audio stream is specifically an audio stream compliant with a preset speech coding standard, and the preset speech coding standard may be an Adaptive Multi-Rate (AMR) coding standard, an Advanced Audio Coding (AAC) standard, or a High-Efficiency Advanced Audio Coding (HEAAC) standard, or the like. The to-be-evaluated audio stream includes multiple audio data packets, where each audio data packet includes a packet header and an audio payload, and the audio payload includes at least one audio frame. Each audio data packet in the to-be-evaluated audio stream includes the same number of audio frames.

An audio stream often has a silence part, for example, a talk interval, and therefore, audio data packets may be classified into two types: non-silence audio data packet and silence audio data packet. When audio frames in an audio data packet are all silence audio frames, the audio data packet is a silence audio data packet; and when at least one non-silence audio frame exists in an audio data packet, the audio data packet is at least one non-silence audio data packet. Because a silence frame does not include any useful information, and loss of a silence frame does not affect audio stream quality either, when audio data packets in a to-be-evaluated audio stream are all silence audio data packets, no quality evaluation is performed on the to-be-evaluated audio stream.

In a process of actual application, the numbers of compressed bytes of non-silence audio frames in an audio stream, which is processed by different speech coding standards, are different. For example, Table 1 lists the number of compressed bytes of each non-silence audio frame in different coding modes when an AMR coding standard is used. In addition, because a length of a silence audio frame is much less than a length of a non-silence audio frame, whether an audio data packet is at least one non-silence audio data packet or a silence audio data packet may be determined according to a length of an audio payload in the audio data packet.

TABLE 1

| | Coding rate | Length of a non-silence audio frame |
|---|---|---|
| Coding mode | (kb/s) | (Byte) |
| AMR475 | 4.75 | 14 |
| AMR515 | 5.15 | 15 |
| AMR59 | 5.9 | 17 |
| AMR67 | 6.7 | 19 |
| AMR74 | 7.4 | 21 |
| AMR795 | 7.95 | 22 |
| AMR102 | 10.2 | 28 |
| AMR122 | 12.2 | 33 |

All non-silence audio data packets in the to-be-evaluated audio stream are evaluated to generate audio quality evaluation information. Evaluation of audio quality of a non-silence part in the to-be-evaluated audio stream may be specifically implemented by using a G.1070 audio quality evaluation method, and may also be implemented by using another method for evaluating audio quality.

In the method for evaluating audio stream quality according to this embodiment of the present invention, an apparatus for evaluating audio stream quality determines at least one non-silence audio data packet in a to-be-evaluated audio stream, where the to-be-evaluated audio stream includes at least one non-silence audio data packet, and each non-silence audio data packet includes at least one non-silence audio frame; and evaluates the at least one non-silence audio data packet in the to-be-evaluated audio stream to generate audio quality evaluation information. Because a silence audio data packet does not include any useful information, audio stream quality evaluation is performed only on at least one non-silence audio data packet in a to-be-evaluated audio stream, which can avoid impact of a silence part on evaluation of audio quality, thereby improving accuracy of evaluating audio stream quality.

FIG. 2 is a flowchart of another method for evaluating audio stream quality according to an embodiment of the present invention. As shown in FIG. 2, in this embodiment, the step 20 of evaluating the at least one non-silence audio data packet in the to-be-evaluated audio stream to generate audio quality evaluation information may specifically include:

Step 201: Determine a bit rate of the at least one non-silence audio data packet in the to-be-evaluated audio stream, and acquire code compression quality information according to the bit rate.

Step 202: Determine packet loss status information of the at least one non-silence audio data packet in the to-be-evaluated audio stream, and generate the audio quality evaluation information according to the code compression quality information and the packet loss status information.

Specifically, code compression quality information varies with different speech coding standards. The code compression quality information may reflect a status of code compression quality according to the speech coding standard, and may also reflect a status of audio quality when no audio data packet is lost in an audio stream in a process of audio transmission. A correspondence between a bit rate and code compression quality information may be preset according to experiment data. A bit rate of the at least one non-silence audio data packet in the to-be-evaluated audio stream is determined, and code compression quality information corresponding to the bit rate is acquired.

Packet loss status information of the at least one non-silence audio data packet in the to-be-evaluated audio stream may specifically include information such as a packet loss rate, loss frequency or an average loss length. The packet loss status information of the at least one non-silence audio data packet is used to indicate a packet loss condition of the at least one non-silence audio data packet. In a process of evaluating audio quality of the to-be-evaluated audio stream, only a packet loss condition of the at least one non-silence audio data packet is considered, which can avoid impact of loss of a silence audio data packet on evaluation of audio quality, thereby improving accuracy of evaluating audio quality.

In this embodiment, the step 201 of determining a bit rate of the at least one non-silence audio data packet in the to-be-evaluated audio stream may specifically be:

determining a sum of bits of all non-silence audio frames included in the at least one non-silence audio data packet in the to-be-evaluated audio stream and a sum of time lengths of all the non-silence audio frames, and generating the bit rate according to the sum of bits and the sum of time lengths.

Specifically, information included in a packet header part of an audio data packet is fixed according to a preset speech coding standard, where a packet header of an audio data packet generally includes a Real-Time Transport Protocol (RTP) header, a User Datagram Protocol (UDP) header, and an Internet Protocol (IP) header. If the preset speech coding standard is a speech coding standard applicable to a broadcast domain, a packet header of an audio data packet may further include a transport stream (TS) header. Lengths of an RTP header, a UDP header, an IP header, and a TS header are fixed, and a length of a packet header may be determined according to the lengths of the RTP header, the UDP header, the IP header and the TS header. An effective length of an audio payload in an audio data packet may be obtained by subtracting the length of the packet header from a total length of the audio data packet. For each non-silence audio data packet, because the number of audio frames included in an audio payload is definite, and a length of a non-silence audio frame is definite, the number and bits of non-silence audio frames may be determined. A time length of at least one non-silence audio data packet may be determined according to a timestamp of an RTP header in the packet header of the at least one non-silence audio data packet, and further, a time length of a non-silence audio frame in the at least one non-silence audio data packet may be determined. Therefore, a bit rate R is calculated by applying the following formula:

$$R = \frac{{\sum }_{i = 1}^{M} {B}_{i}}{{\sum }_{i = 1}^{M} {Duration}_{i}} ,$$

where M is the number of non-silence audio frames in the to-be-evaluated audio stream, Bᵢ is the number of bits of the i^{th} non-silence audio frame, and Durationᵢ is a time length of the i^{th} non-silence audio frame.

In this embodiment, the packet loss status information is a packet loss rate. The step 202 of determining packet loss status information of the at least one non-silence audio data packet in the to-be-evaluated audio stream, and generating the audio quality evaluation information according to the code compression quality information and the packet loss status information may specifically be:

determining a packet loss rate of the at least one non-silence audio data packet in the to-be-evaluated audio stream, and generating the audio quality evaluation information according to the code compression quality information and the packet loss rate.

In this embodiment, the determining a packet loss rate of the at least one non-silence audio data packet in the to-be-evaluated audio stream may specifically be:

determining the total number of lost audio data packets and the number of lost silence audio data packets in the to-be-evaluated audio stream, determining the number of lost non-silence audio data packets according to the total number of the lost audio data packets and the number of the lost silence audio data packets, and generating the packet loss rate according to the number of the at least one lost non-silence audio data packets and the number of non-silence audio data packets in the to-be-evaluated audio stream.

Specifically, an RTP header in a packet header of an audio data packet has a serial number field to indicate a sequence of the audio data packet, and the total number of lost audio data packets may be determined according to a serial number field of an RTP header of each audio data packet in the to-be-evaluated audio stream. If two audio data packets adjacent to a lost audio data packet are both silence audio data packets, the lost audio data packet is a silence audio data packet. For example, serial numbers of audio data packets in the to-be-evaluated audio stream are separately 1, 2, 3, 5 and 6. Then, it may be determined that an audio data packet with a serial number 4 is lost. If audio data packets with serial numbers 3 and 5 are both silence audio data packets, the lost audio data packet with the serial number 4 is also a silence audio data packet, and therefore, the number of lost silence audio data packets may be determined. The number of lost non-silence audio data packets is obtained by subtracting the number of lost silence audio data packets from the total number of lost audio data packets.

A packet loss rate PLR is calculated by applying the following formula:

$$PLR = \frac{N 1}{N 2} ,$$

where N1 the number of lost non-silence audio data packets, and N2 is the number of non-silence audio data packets in the to-be-evaluated audio stream.

In this embodiment, the generating the audio quality evaluation information according to the code compression quality information and the packet loss rate may specifically be:

calculating the audio quality evaluation information Q by applying the following formula:

Q=Q_{c}−a₁·Q_{c}·e^{a}^{₂}^{PLR},

where Q_{c} is the code compression quality information, PLR is the packet loss rate, and a₁ and a₂ are separately a preset coefficient.

Specifically, a₁ and a₂ are preset coefficients, and may be obtained by training a training database.

In this embodiment, the packet loss status information is loss frequency. The step 202 of determining packet loss status information of the at least one non-silence audio data packet in the to-be-evaluated audio stream, and generating the audio quality evaluation information according to the code compression quality information and the packet loss status information may specifically be:

determining loss frequency of the at least one non-silence audio data packet in the to-be-evaluated audio stream, and generating the audio quality evaluation information according to the code compression quality information and the loss frequency.

In this embodiment, the determining loss frequency of the at least one non-silence audio data packet in the to-be-evaluated audio stream may specifically be:

determining the number of loss times of the at least one non-silence audio data packet in the to-be-evaluated audio stream, determining the sum of time lengths of all the non-silence audio frames included in the at least one non-silence audio data packet in the to-be-evaluated audio stream, and generating the loss frequency according to the number of loss times and the sum of time lengths of all the non-silence audio frames.

Specifically, the number of loss times of the at least one non-silence audio data packet is the total number of times of occurrence of packet loss events of the at least one non-silence audio data packet included in the to-be-evaluated audio stream, and continuous packet losses belong to one packet loss event. For example, audio data packets with serial numbers 1, 2, 3, 6, 8 and 9 respectively are all non-silence audio data packets, and serial numbers of lost non-silence audio data packets are 4, 5 and 7 respectively. Even if the number of lost non-silence audio data packets is 3, non-silence audio data packets with serial numbers 4 and 5 are continuous audio data packets, and therefore, the number of loss times of the at least one non-silence audio data packets is 2.

Loss frequency LR is calculated by applying the following formula:

$$LR = \frac{N 3}{{\sum }_{i = 1}^{M} {Duration}_{i}} ,$$

where N3 is the number of loss times of at least one non-silence audio data packet, M is the number of non-silence audio frames in the to-be-evaluated audio stream, and Durationᵢ is a time length of the i^{th} non-silence audio frame.

In this embodiment, the generating the audio quality evaluation information according to the code compression quality information and the loss frequency may specifically be:

calculating the audio quality evaluation information Q by applying the following formula:

Q=Q_{c}−a₃·Q_{c}·e^{a}^{₄}^{LR},

where Q_{c} is the code compression quality information, LR is the loss frequency, and a₃ and a₄ are separately a preset coefficient.

Specifically, a₃ and a₄ are preset coefficients, and may be obtained by training a training database.

In this embodiment, the packet loss status information is an average loss length; and the determining packet loss status information of the at least one non-silence audio data packet in the to-be-evaluated audio stream, and generating the audio quality evaluation information according to the code compression quality information and the packet loss status information may specifically be:

determining an average loss length of the at least one non-silence audio data packet in the to-be-evaluated audio stream, and generating the audio quality evaluation information according to the code compression quality information and the average loss length.

In this embodiment, the determining an average loss length of the at least one non-silence audio data packet in the to-be-evaluated audio stream may specifically be:

determining at least one lost non-silence audio data packet in the to-be-evaluated audio stream, determining a sum of time lengths of the at least one lost non-silence audio data packet, determining the number of loss times of the at least one non-silence audio data packet in the to-be-evaluated audio stream, and generating the average loss length according to the sum of time lengths and the number of loss times.

Specifically, an RTP header in a packet header of an audio data packet has a serial number field to indicate a sequence of the audio data packet, and a lost audio data packet may be determined according to a serial number field of an RTP header of each audio data packet in the to-be-evaluated audio stream. If two audio data packets adjacent to a lost audio data packet are both silence audio data packets, the lost audio data packet is a silence audio data packet. A lost non-silence audio data packet is determined by determining the lost silence audio data packet. A sum of time lengths of the at least one lost non-silence audio data packet may be determined according to a timestamp of an RTP header of an audio data packet in the to-be-evaluated audio stream.

The number of loss times of the at least one non-silence audio data packet is the total number of times of occurrence of packet loss events of the at least one non-silence audio data packet included in the to-be-evaluated audio stream, and continuous packet losses belong to one packet loss event. For example, audio data packets with serial numbers 1, 2, 3, 6, 8 and 9 respectively are all non-silence audio data packets, and serial numbers of lost non-silence audio data packets are 4, 5 and 7 respectively. Even if the number of lost non-silence audio data packets is 3, non-silence audio data packets with serial numbers 4 and 5 are continuous audio data packets, and therefore, the number of loss times of the at least one non-silence audio data packets is 2.

An average loss length LD is calculated by applying the following formula:

$$LD = \frac{T 1}{N 3} ,$$

where T1 is a sum of time lengths of at least one lost non-silence audio data packet, and N3 is the number of loss times of at least one lost non-silence audio data packet.

In this embodiment, the generating the audio quality evaluation information according to the code compression quality information and the average loss length may specifically be:

calculating the audio quality evaluation information Q by applying the following formula:

Q=Q_{c}−a₅·Q_{c}·e^{a}^{₆}^{LD},

where Q_{c} is the code compression quality information, LD is the average loss length, and a₅ and a₆ are separately a preset coefficient.

Specifically, a₅ and a₆ are preset coefficients, and may be obtained by training a training database.

In a process of actual application, packet loss status information of at least one non-silence audio data packet may further include another information that can reflect a packet loss condition of the at least one non-silence audio data packet, which is not limited in this embodiment. Correspondingly, a manner of generating the audio quality evaluation information according to code compression quality information and packet loss status information may also be another manner, which is not limited in this embodiment.

For example, packet loss status information of at least one non-silence audio data packet may include loss frequency and a loss length. Loss frequency and a loss length may be obtained by using the method provided in the foregoing embodiment, and may also be obtained in another manner. For example, loss frequency

$$LR = \frac{N 3}{T 1} ,$$

where N3 is the number of loss times of at least one non-silence audio data packet, and T1 is a sum of time lengths of at least one lost non-silence audio data packet. Loss length

$$LD = \frac{N 1}{N 3} ,$$

where N1 the number of lost non-silence audio data packets, and N3 is the number of loss times of at least one non-silence audio data packet.

the audio quality evaluation information Q is calculated by applying the following formula:

Q=(Q_{C}−1)((1−a₁₁)e^{-V□LR/a}^{₁₂}+a₁₁e^{-V□LR/a}^{₁₃})+1,

V=a₁₄(LD−1)+1,

where Q_{c} is the code compression quality information, and a₁₁, a₁₂, a₁₃ and a₁₄ are preset coefficients and may be obtained by training a training database. For example, in a model parameter of an AAC bit stream, a₁₁=0.5145, a₁₂=106658, a₁₃=5.0921, and a₁₄=0.0560.

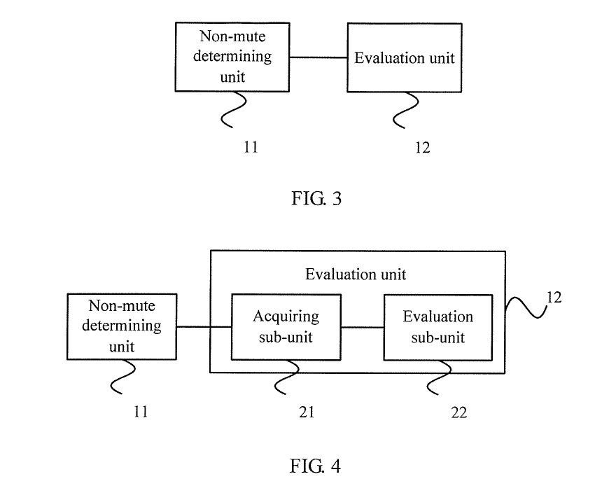

FIG. 3 is a schematic structural diagram of an apparatus for evaluating audio stream quality according to an embodiment of the present invention. As shown in FIG. 3, the apparatus for evaluating audio stream quality according to this embodiment may implement the steps of the method for evaluating the audio stream quality according to any embodiment of the present invention, and is not described any further herein. The apparatus for evaluating audio stream quality according to this embodiment specifically includes a non-silence determining unit 11 and an evaluation unit 12. The non-silence determining unit 11 is configured to determine at least one non-silence audio data packet in a to-be-evaluated audio stream, where the to-be-evaluated audio stream includes at least one non-silence audio data packet, and each non-silence audio data packet includes at least one non-silence audio frame. The evaluation unit 12 is connected to the non-silence determining unit 11, and configured to evaluate the at least one non-silence audio data packet in the to-be-evaluated audio stream to generate audio quality evaluation information.

In the apparatus for evaluating audio stream quality according to this embodiment, the non-silence determining unit 11 determines at least one non-silence audio data packet in a to-be-evaluated audio stream, where the to-be-evaluated audio stream includes at least one non-silence audio data packet, and each non-silence audio data packet includes at least one non-silence audio frame; and the evaluation unit 12 evaluates the at least one non-silence audio data packet in the to-be-evaluated audio stream to generate audio quality evaluation information. Because a silence audio data packet does not include any useful information, audio stream quality evaluation is performed only on at least one non-silence audio data packet in a to-be-evaluated audio stream, which can avoid impact of a silence part on evaluation of audio quality, thereby improving accuracy of evaluating audio stream quality.

FIG. 4 is a schematic structural diagram of another apparatus for evaluating audio stream quality according to an embodiment of the present invention. As shown in FIG. 4, in this embodiment, the evaluation unit 12 may specifically include an acquiring sub-unit 21 and an evaluation sub-unit 22. The acquiring sub-unit 21 is connected to the non-silence determining unit 11 and configured to determine a bit rate of the at least one non-silence audio data packet in the to-be-evaluated audio stream, and acquire code compression quality information according to the bit rate. The evaluation sub-unit 22 is connected to the acquiring sub-unit 21 and configured to determine packet loss status information of the at least one non-silence audio data packet in the to-be-evaluated audio stream, and generate the audio quality evaluation information according to the code compression quality information and the packet loss status information.

Packet loss status information of the at least one non-silence audio data packet in the to-be-evaluated audio stream may specifically include information such as a packet loss rate, loss frequency or an average loss length. The packet loss status information of the at least one non-silence audio data packet is used to indicate a packet loss condition of the at least one non-silence audio data packet. In a process of evaluating audio quality of the to-be-evaluated audio stream, only a packet loss condition of the at least one non-silence audio data packet is considered, which can avoid impact of loss of a silence audio data packet on evaluation of audio quality, thereby improving accuracy of evaluating audio quality.

In this embodiment, the acquiring sub-unit 21 is further configured to determine a sum of bits of all non-silence audio frames included in the at least one non-silence audio data packet in the to-be-evaluated audio stream and a sum of time lengths of all the non-silence audio frames, and generate the bit rate according to the sum of bits and the sum of time lengths.

In this embodiment, the packet loss status information is a packet loss rate; and the evaluation sub-unit 22 is further configured to determine a packet loss rate of non-silence audio data packet in the to-be-evaluated audio stream, and generate the audio quality evaluation information according to the code compression quality information and the packet loss rate.

In this embodiment, the evaluation sub-unit 22 is further configured to determine the total number of lost audio data packets and the number of lost silence audio data packets in the to-be-evaluated audio stream, determine the number of lost non-silence audio data packets according to the total number of the lost audio data packets and the number of the lost silence audio data packets, and generate the packet loss rate according to the number of the at least one lost non-silence audio data packets and the number of non-silence audio data packets in the to-be-evaluated audio stream.

In this embodiment, the evaluation sub-unit 22 is further configured to calculate the audio quality evaluation information Q by applying the following formula:

Q=Q_{c}−a₁·Q_{c}·e^{a}^{₂}^{PLR},

where Q_{c} is the code compression quality information, PLR is the packet loss rate, and a₁ and a₂ are separately a preset coefficient.

In this embodiment, the packet loss status information is loss frequency; and the evaluation sub-unit 22 is further configured to determine loss frequency of the at least one non-silence audio data packet in the to-be-evaluated audio stream, and generate the audio quality evaluation information according to the code compression quality information and the loss frequency.

In this embodiment, the evaluation sub-unit 22 is further configured to determine the number of loss times of the at least one non-silence audio data packet in the to-be-evaluated audio stream, determine the sum of time lengths of all the non-silence audio frames included in the at least one non-silence audio data packet in the to-be-evaluated audio stream, and generate the loss frequency according to the number of loss times and the sum of time lengths of all the non-silence audio frames.

In this embodiment, the evaluation sub-unit 22 is further configured to calculate the audio quality evaluation information Q by applying the following formula:

Q=Q_{c}−a₃·Q_{c}·e^{a}^{₄}^{LR},

where Q_{c} is the code compression quality information, LR is the loss frequency, and a₃ and a₄ are separately a preset coefficient.

In this embodiment, the packet loss status information is an average loss length; and the evaluation sub-unit 22 is further configured to determine an average loss length of the at least one non-silence audio data packet in the to-be-evaluated audio stream, and generate the audio quality evaluation information according to the code compression quality information and the average loss length.

In this embodiment, the evaluation sub-unit 22 is further configured to determine at least one lost non-silence audio data packet in the to-be-evaluated audio stream, determine a sum of time lengths of the at least one lost non-silence audio data packet, determine the number of loss times of the at least one non-silence audio data packet in the to-be-evaluated audio stream, and generate the average loss length according to the sum of time lengths and the number of loss times.

In this embodiment, the evaluation sub-unit 22 is further configured to calculate the audio quality evaluation information Q by applying the following formula:

Q=Q_{c}−a₅·Q_{c}·e^{a}^{₆}^{LD},

where Q_{c} is the code compression quality information, LD is the average loss length, and a₅ and a₆ are separately a preset coefficient.

In the method and the apparatus for evaluating audio stream quality according to this embodiment of the present invention, because a silence audio data packet does not include any useful information, audio stream quality evaluation is performed only on at least one non-silence audio data packet in a to-be-evaluated audio stream, which can avoid impact of a silence part on evaluation of audio quality, thereby improving accuracy of evaluating audio stream quality. In addition, the method and the apparatus for evaluating audio stream quality according to this embodiment of the present invention have low complexity in calculation, are applicable to an audio stream with payload encryption, and can be widely applied to evaluation and monitoring of quality of a network audio stream and a multimedia stream.

A person of ordinary skill in the art may understand that all or a part of the steps of the method embodiments may be implemented by a program instructing relevant hardware. The program may be stored in a computer readable storage medium. When the program runs, the steps of the method embodiments are performed. The foregoing storage medium includes: any medium that can store program code, such as a ROM, a RAM, a magnetic disk, or an optical disc.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of the embodiments of the present invention.

What is claimed is:

1. A method for evaluating audio stream quality performed by an apparatus for evaluating audio stream quality, the apparatus comprising a processor, the method comprising:
determining at least one non-silence audio data packet in a to-be-evaluated audio stream, wherein the to-be-evaluated audio stream comprises at least one non-silence audio data packet, and each non-silence audio data packet comprises at least one non-silence audio frame; and
evaluating the at least one non-silence audio data packet in the to-be-evaluated audio stream to generate audio quality evaluation information.

2. The method for evaluating audio stream quality according to claim 1, wherein evaluating the at least one non-silence audio data packet in the to-be-evaluated audio stream to generate audio quality evaluation information comprises:
determining a bit rate of the at least one non-silence audio data packet in the to-be-evaluated audio stream, and acquiring code compression quality information according to the bit rate; and
determining packet loss status information of the at least one non-silence audio data packet in the to-be-evaluated audio stream, and generating the audio quality evaluation information according to the code compression quality information and the packet loss status information.

3. The method for evaluating audio stream quality according to claim 2, wherein determining a bit rate of the at least one non-silence audio data packet in the to-be-evaluated audio stream comprises:
determining a sum of bits of all non-silence audio frames comprised in the at least one non-silence audio data packet in the to-be-evaluated audio stream and a sum of time lengths of all the non-silence audio frames, and generating the bit rate according to the sum of bits and the sum of time lengths.

4. The method for evaluating audio stream quality according to claim 2, wherein:
the packet loss status information is a packet loss rate; and
determining packet loss status information of the at least one non-silence audio data packet in the to-be-evaluated audio stream, and generating the audio quality evaluation information according to the code compression quality information and the packet loss status information comprises:
determining a packet loss rate of the at least one non-silence audio data packet in the to-be-evaluated audio stream, and generating the audio quality evaluation information according to the code compression quality information and the packet loss rate.

5. The method for evaluating audio stream quality according to claim 4, wherein determining a packet loss rate of the at least one non-silence audio data packet in the to-be-evaluated audio stream comprises:
determining the total number of lost audio data packets and the number of lost silence audio data packets in the to-be-evaluated audio stream, determining the number of lost non-silence audio data packets according to the total number of the lost audio data packets and the number of the lost silence audio data packets, and generating the packet loss rate according to the number of the at least one lost non-silence audio data packets and the number of non-silence audio data packets in the to-be-evaluated audio stream.

6. The method for evaluating audio stream quality according to claim 4, wherein generating the audio quality evaluation information according to the code compression quality information and the packet loss rate comprises:
calculating the audio quality evaluation information Q by applying the following formula:
Q=Q_{c}−a₁·Q_{c}·e^{a}^{₂}^{PLR},
wherein Q_{c} is the code compression quality information, PLR is the packet loss rate, and a₁ and a₂ are separately a preset coefficient.

7. The method for evaluating audio stream quality according to claim 2, wherein:
the packet loss status information is loss frequency; and
determining packet loss status information of the at least one non-silence audio data packet in the to-be-evaluated audio stream, and generating the audio quality evaluation information according to the code compression quality information and the packet loss status information comprises:
determining loss frequency of the at least one non-silence audio data packet in the to-be-evaluated audio stream, and generating the audio quality evaluation information according to the code compression quality information and the loss frequency.

8. The method for evaluating audio stream quality according to claim 7, wherein determining loss frequency of the at least one non-silence audio data packet in the to-be-evaluated audio stream comprises:
determining the number of loss times of the at least one non-silence audio data packet in the to-be-evaluated audio stream, determining the sum of time lengths of all the non-silence audio frames comprised in the at least one non-silence audio data packet in the to-be-evaluated audio stream, and generating the loss frequency according to the number of loss times and the sum of time lengths of all the non-silence audio frames.

9. The method for evaluating audio stream quality according to claim 7, wherein generating the audio quality evaluation information according to the code compression quality information and the loss frequency comprises:
calculating the audio quality evaluation information Q by applying the following formula:
Q=Q_{c}−a₃·Q_{c}·e^{a}^{₄}^{PLR},
wherein Q_{c} is the code compression quality information, LR is the loss frequency, and a₃ and a₄ are separately a preset coefficient.

10. The method for evaluating audio stream quality according to claim 2, wherein:
the packet loss status information is an average loss length; and
determining packet loss status information of the at least one non-silence audio data packet in the to-be-evaluated audio stream, and generating the audio quality evaluation information according to the code compression quality information and the packet loss status information comprises:
determining an average loss length of the at least one non-silence audio data packet in the to-be-evaluated audio stream, and generating the audio quality evaluation information according to the code compression quality information and the average loss length.

11. The method for evaluating audio stream quality according to claim 10, wherein determining an average loss length of the at least one non-silence audio data packet in the to-be-evaluated audio stream comprises:
determining at least one lost non-silence audio data packet in the to-be-evaluated audio stream, determining a sum of time lengths of the at least one lost non-silence audio data packet, determining the number of loss times of the at least one non-silence audio data packet in the to-be-evaluated audio stream, and generating the average loss length according to the sum of time lengths and the number of loss times.

12. The method for evaluating audio stream quality according to claim 10, wherein generating the audio quality evaluation information according to the code compression quality information and the average loss length comprises:
calculating the audio quality evaluation information Q by applying the following formula:
Q=Q_{c}−a₅·Q_{c}·e^{a}^{₆}^{LD},
wherein Q_{c} is the code compression quality information, LD is the average loss length, and a₅ and a₆ are separately a preset coefficient.

13. An apparatus for evaluating audio stream quality, the apparatus comprising:
a processor;
a non-silence determining unit, configured to determine at least one non-silence audio data packet in a to-be-evaluated audio stream, wherein the to-be-evaluated audio stream comprises at least one non-silence audio data packet, and each non-silence audio data packet comprises at least one non-silence audio frame; and
an evaluation unit, connected to the non-silence determining unit and configured to evaluate the at least one non-silence audio data packet in the to-be-evaluated audio stream to generate audio quality evaluation information.

14. The apparatus for evaluating audio stream quality according to claim 13, wherein the evaluation unit comprises:
an acquiring sub-unit, connected to the non-silence determining unit and configured to determine a bit rate of the at least one non-silence audio data packet in the to-be-evaluated audio stream, and acquire code compression quality information according to the bit rate; and
an evaluation sub-unit, connected to the acquiring sub-unit and configured to determine packet loss status information of the at least one non-silence audio data packet in the to-be-evaluated audio stream, and generate the audio quality evaluation information according to the code compression quality information and the packet loss status information.

15. The apparatus for evaluating audio stream quality according to claim 14, wherein the acquiring sub-unit is further configured to determine a sum of bits of all non-silence audio frames comprised in the at least one non-silence audio data packet in the to-be-evaluated audio stream and a sum of time lengths of all the non-silence audio frames, and generate the bit rate according to the sum of bits and the sum of time lengths.

16. The apparatus for evaluating audio stream quality according to claim 14, wherein:
the packet loss status information is a packet loss rate; and
the evaluation sub-unit is further configured to determine a packet loss rate of the at least one non-silence audio data packet in the to-be-evaluated audio stream, and generate the audio quality evaluation information according to the code compression quality information and the packet loss rate.

17. The apparatus for evaluating audio stream quality according to claim 16, wherein:
the evaluation sub-unit is further configured to determine the total number of lost audio data packets and the number of lost silence audio data packets in the to-be-evaluated audio stream, determine the number of lost non-silence audio data packets according to the total number of the lost audio data packets and the number of the lost silence audio data packets, and generate the packet loss rate according to the number of the at least one lost non-silence audio data packets and the number of non-silence audio data packets in the to-be-evaluated audio stream.

18. The apparatus for evaluating audio stream quality according to claim 16, wherein the evaluation sub-unit is further configured to calculate the audio quality evaluation information Q by applying the following formula:
Q=Q_{c}−a₁·Q_{c}·e^{a}^{₂}^{PLR},
wherein Q_{c} is the code compression quality information, PLR is the packet loss rate, and a₁ and a₂ are separately a preset coefficient.

19. The apparatus for evaluating audio stream quality according to claim 14, wherein:
the packet loss status information is loss frequency; and
the evaluation sub-unit is further configured to determine loss frequency of the at least one non-silence audio data packet in the to-be-evaluated audio stream, and generate the audio quality evaluation information according to the code compression quality information and the loss frequency.

20. The apparatus for evaluating audio stream quality according to claim 19, wherein the evaluation sub-unit is further configured to determine the number of loss times of the at least one non-silence audio data packet in the to-be-evaluated audio stream, determine the sum of time lengths of all the non-silence audio frames comprised in the at least one non-silence audio data packet in the to-be-evaluated audio stream, and generate the loss frequency according to the number of loss times and the sum of time lengths of all the non-silence audio frames.

21. The apparatus for evaluating audio stream quality according to claim 19, wherein the evaluation sub-unit is further configured to calculate the audio quality evaluation information Q by applying the following formula:
Q=Q_{c}−a₃·Q_{c}·e^{a}^{₄}^{LR},
wherein Q_{c} is the code compression quality information, LR is the loss frequency, and a₃ and a₄ are separately a preset coefficient.

22. The apparatus for evaluating audio stream quality according to claim 14, wherein:
the packet loss status information is an average loss length; and
the evaluation sub-unit is further configured to determine an average loss length of the at least one non-silence audio data packet in the to-be-evaluated audio stream, and generate the audio quality evaluation information according to the code compression quality information and the average loss length.

23. The apparatus for evaluating audio stream quality according to claim 22, wherein the evaluation sub-unit is further configured to determine at least one lost non-silence audio data packet in the to-be-evaluated audio stream, determine a sum of time lengths of the at least one lost non-silence audio data packet, determine the number of loss times of the at least one non-silence audio data packet in the to-be-evaluated audio stream, and generate the average loss length according to the sum of time lengths and the number of loss times.

24. The apparatus for evaluating audio stream quality according to claim 22, wherein the evaluation sub-unit is further configured to calculate the audio quality evaluation information Q by applying the following formula:
Q=Q_{c}−a₅·Q_{c}·e^{a}^{₆}^{LD},
wherein Q_{c} is the code compression quality information, LD is the average loss length, and a₅ and a₆ are separately a preset coefficient.
